(19) United States
(12) Patent Application Publication
(10) Pub. No.: US 2011/0320559 A1
(43) Pub. Date: Dec. 29, 2011

(54) REMOTE ACCESS WITH MEDIA TRANSLATION

(75) Inventor: George Foti, Dollard-des-Ormeaux (CA)

(73) Assignee: TELEFONAKTIEBOLAGET L M ERICSSON (PUBL), Stockholm (SE)

(21) Appl. No.: 12/821,512

(22) Filed: Jun. 23, 2010

(51) Int. Cl. G06F 15/16

(52) U.S. Cl. 709/217; 709/246

(57) ABSTRACT

A transcoding solution for enabling access to content in a home archive provides access to mobile and other devices through the use of a network based transcoding node. The user can specify a transcoding node in a content request so that the hosted content is received by the transcoding node, transcoded and then sent to the requesting node. Such use of network based transcoding service allows for dedicated transcoding equipment to be used removing the need for the end user to employ his own server.

### TECHNICAL FIELD

This disclosure relates generally to transcoding content in a content delivery network.

### BACKGROUND

Conventionally, television signals have been broadcast from stations using analogue over-the-air transmissions. In such a process, the content is encoded as s signal using a standard encoding format such as PAL or NTSC. As technology evolved, transmission of content was replicated over a dedicated cable infrastructure, and in some cases, was only provided using this infrastructure. It was decided, a priori, how the content was to be encoded by the standards that served the broadcaster and the receivers.

As transmission moved from analogue to digital domains, encoding standards had to be agreed upon again. Additionally, some of the transmissions moved from being a broadcast available to all receivers to being either multicast to smaller groups of users under their control or unicast to individual users on demand.

As the distribution of content progressed from analogue broadcast over a shared resource to a digital delivery over a limited resource, particular focus was paid to how the content was encoded for both content control and bandwidth efficiency purposes.

Presently, much focus is paid to Internet Protocol Television (IPTV) which uses a packet based delivery mechanism controlled by an Internet Multimedia Subsystem (IMS) based network employing the Session Initiation Protocol (SIP) as a preferred signaling layer. In such a distribution network, users can be authenticated before the selected content is delivered to them.

Because the content is digitally encoded, and the delivery can be viewed as network agnostic, there is often interest in, or demand for, subscribers to be provided with remote access functionality. Remote access allows a user to view content stored in the home. That content is typically digitally encoded to be viewed from conventional IPTV Terminal Function (ITF) terminals. A common desire is for the content to be delivered to a mobile platform implementing ITF features in software. In some instances, users wish to perform the reverse operation and would like to access content encoded for a mobile platform on another device such as a set-top-box based ITF.

This functionality is somewhat supported through such available standards as ETSI TS 185 010 V.2.1.1, which allows a device, such as a mobile phone, to access content stored in the home. The mobile device typically employs a remote access client capable of accessing content delivered to the home based on a Digital Living Network Alliance (DLNA) and Universal Plug and Play (uPnP) procedures. This entails establishing an IMS channel between the mobile device and the IMS Gateway (IG) serving the home, with a specified Quality of Service (QoS). The transmissions over the channel typically employ IPSEC to secure the traffic over the channel.

Decisions on the content to stream to the mobile device can then be made, necessitating a subsequent IMS channel to be created. This double channel helps to avoid double encryption given that the first IMS channel established for DLNA control traffic is encrypted, in addition to the content which is also encrypted.

One of many concerns in such a system is that the content must be delivered in a format that can be decoded and rendered by the mobile device. Encoding a content stream with the intent of having that stream decoded at an ITF implemented in a Set Top Box (STB), allows for assumptions to be made about both the available processing power for decoding the content stream and about the available bandwidth between the content source and the STB. The content encoded with these assumptions in mind is the content stored at the home server, and is often inappropriate or non-ideal for transmission to the mobile device. Because of these assumptions, many content sources make content available in a format ideally suited for decoding by STB's. Through the use of dedicated decoding hardware, an STB is able to decode a content stream that is encoded with the goal of maintaining high video quality without consuming inordinate amounts of bandwidth. As mentioned earlier, such a content stream is often non-deal for transmission to and rendering on a mobile device.

Typically a content provider encodes content for delivery based on a number of factors. The available bandwidth to the receiver, the intended display resolution, desired image quality and the codec's available at the decoder all factor in to the decisions on how to encode content. When content is forwarded to a mobile device, many of the assumptions become invalid. The bandwidth available is often reduced, the desired resolution is often different, due to a smaller screen size the required quality is different, and the ability to decode particular encoding techniques, which may rely upon powerful processors for decoding, may be lacking. As such, simply forwarding content to the mobile device after receiving it at the home is an inefficient process.

The encoded stream sent to an ITF and optionally stored in a server is determined through a negotiation process between the ITF and the content source. During this process, QoS guarantees can be required, and often the ITF and the content source will exchange lists of available codecs. A common ground is then found and an appropriately encoded content stream is then delivered. If this content is later requested by a mobile device a codec mismatch will most likely occur in the negotiation process between user equipment, such as the mobile device, and the IMS gateway (IG). In this negotiation process based on IMS, as per ETSI TS 185 010 V.2.1.1, the IG terminates the IMS session signaling. Given the codec mismatch the IG will be forced to reject the IMS session request from the mobile device.

In some solutions to this problem, a transcoding process is undertaken either at the IG or at a node in the home network. The process is often transparent to the mobile device and results in a transcoded signal that is suitable for decoding by the mobile device. Often setting up such a service is difficult to configure, requires dedicated hardware, which is to be purchased, installed and configured by the end-user. Furthermore these solutions often introduce security concerns. Content received at in the home network and transcoded by the IG (or other nodes in the user residence) is often encoded without digital rights management. Because the transcoding is left to the user, it is difficult to enforce DRM based rules on content distribution, which is a concern for many content distributors.

For these many reasons, the ability to redirect content to a mobile device is difficult to obtain using conventional mechanisms.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of requesting content from a content source behind a gateway. The method comprises the steps of issuing, over a network interface, a request addressed to the gateway for content from the content source, the request specifying that transcoding of the requested content is desired; receiving, from the gateway, an indication of acceptance of the request; instructing the gateway to begin transmission of the requested content; and receiving, from the transcoding node, a transcoded version of the requested content.

In an embodiment of the first aspect of the present invention, the content source stores digital media content in accordance with standards established by the Digital Living Network Alliance. In another embodiment, the gateway is an Internet Multimedia Subsystem (IMS) gateway. In a further embodiment, specifying that transcoding is desired includes including an indication for another node to transmit the request to a transcoding node and optionally the indication for another node is a tag specifying at least one of a source and target codec.

In yet a further embodiment of the present invention, the step of issuing a request includes generating a Session Initiation Protocol (SIP) INVITE message that may be addressed to the gateway, and transmitted through a transcoding node selected in accordance with the specified desire for transcoding. The SIP INVITE message can be addressed to the gateway through the use of a Universal Resource Indicator associated with the gateway. In another embodiment, the SIP INVITE message includes a Session Description Protocol compliant instruction specifying a preferred format to transcode requested content to. In other embodiments, the step of receiving the indication of acceptance includes receiving a SIP 200 OK message from the transcoding node. The step of instructing can optionally include transmitting a SIP ACK message to the gateway.

In a second aspect of the present invention, there is provided a method of transcoding content on demand. The method comprises the steps of receiving, at a transcoding node, from a requesting node, a request for a transcoded copy of content from a content source; forwarding, to the content source a request for the content; receiving the requested content from the content source in a first encoding format; creating a transcoded copy of the received content by translating the received content from the first encoding format to a second encoding format; and forwarding the transcoded copy of the content to a node determined in accordance with the received request.

In an embodiment of the second aspect of the present invention, the step of receiving the request includes receiving the request from an Internet Protocol Television Control Server on behalf of the requesting node. In another embodiment, the request for transcoded content includes a session description protocol compliant specification of at least one of the first and second encoding formats. In another embodiment, the received request includes the address to which the request for content should be forwarded, where the address may be provided as a universal resource indicator that can be resolved to the address of a gateway through which the content source is accessible. In another embodiment, the step of receiving the request includes receiving the request from a mobile device. In a further embodiment, the request includes a request for content compliant with Digital Living Network Alliance standards. In yet another embodiment, the step of forwarding the transcoded content includes forwarding the transcoded content to the requesting node. In a further embodiment, the step of forwarding the transcoded content includes forwarding the transcoded content to a node specified by the requesting node.

In a third aspect of the present invention, there is provided a transcoding node for receiving requests for transcoded copies of externally hosted content. The transcoding node comprises a transcoder and a transcoding media controller. The transcoder receives externally hosted content in a first encoding format, converts the externally hosted content from the first encoding format to a second encoding format, and transmits the converted content. The transcoding media controller receives the request, generates and transmits a request for the externally hosted content in accordance with the received request, instructs the transcoder to convert content received in response to the transmitted request to a format selected in accordance with the received request, and instructs the transcoder to transmit the converted content to an end user node.

In an embodiment of the third aspect of the present invention, the transcoding node further includes a mobile device interface that can be used to receive the requests for transcoded copies from a mobile device, forward the received requests to the transcoding media controller, and receive the converted content from the transcoder and transmitting the converted content on behalf of the transcoder. In another embodiment, the transcoding node can further include a gateway interface for receiving the request for externally hosted content from the transcoding media controller and for transmitting the request on behalf of the transcoding media controller, for receiving from an external node the requested content and for relaying the received requested content to the transcoder. In a further embodiment, the transcoding node can further include a plurality of transcoders selectable by the transcoding media controller, each of the plurality of transcoders operably connected to the gateway interface for receiving from the interface the received requested content.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates message flow between nodes in an IMS network to establish remote access rights;

FIG. 2 illustrates message flow between nodes in an IMS network to request and establish the transcoding and delivery of a content stream;

FIG. 3 is a flowchart illustrating a method of requesting transcoded content;

FIG. 4 is a flowchart illustrating an exemplary embodiment of the method of FIG. 3;

FIG. 5 is a flowchart illustrating a method of receiving and handling a request for transcoding externally hosted content; and

FIG. 6 is a block diagram illustrating an exemplary transcoding node of the present invention.

### DETAILED DESCRIPTION

The present invention is directed to a system and method for accessing a network based transcoding service for seamlessly transcoding content for user equipment such as a mobile phone.

Problems arising with attempts in the prior art to redirect encoded content streams to mobile devices can be obviated or mitigated through the use of a network based transcoding node. The use of a network based service moves the function of transcoding into the network which allows for a number of enhancements, including the ability to maintain security by applying digital rights management (DRM) protections to the transcoded stream if desired. Additionally, the transcoding node is able to make use of dedicated processing to efficiently provide a wider variety of codecs that can be selected from. In one embodiment of the present invention, when requesting content, the user can indicate that transcoding services are desired. The content retrieved through the IG is then directly provided to a transcoding node selected in accordance with the user indication. Furthermore, if the user indicates specific needs from a transcoding node, a node specific to the user needs can be selected. This allows transcoding services to be selected based on any of a number of different criteria, including the ability of a transcoding node to generate content specifically designed for the screen resolution and codec support of a mobile device. The user indication can be used by the IPTV CS or another network node to select a specific transcoding node, or in some alternate embodiments, the specifying of a particular transcoding node can be done by the user.

A network based transcoding node is typically offered as a service by a network provider. The service can either be provided under a variety of different terms, including a fee based model. The quality of the encoding, the resolution of the encoded content and the particular codec selected can be tailored for user experience more easily than if the transcoding were to happen either at the original content source or at the user premises.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

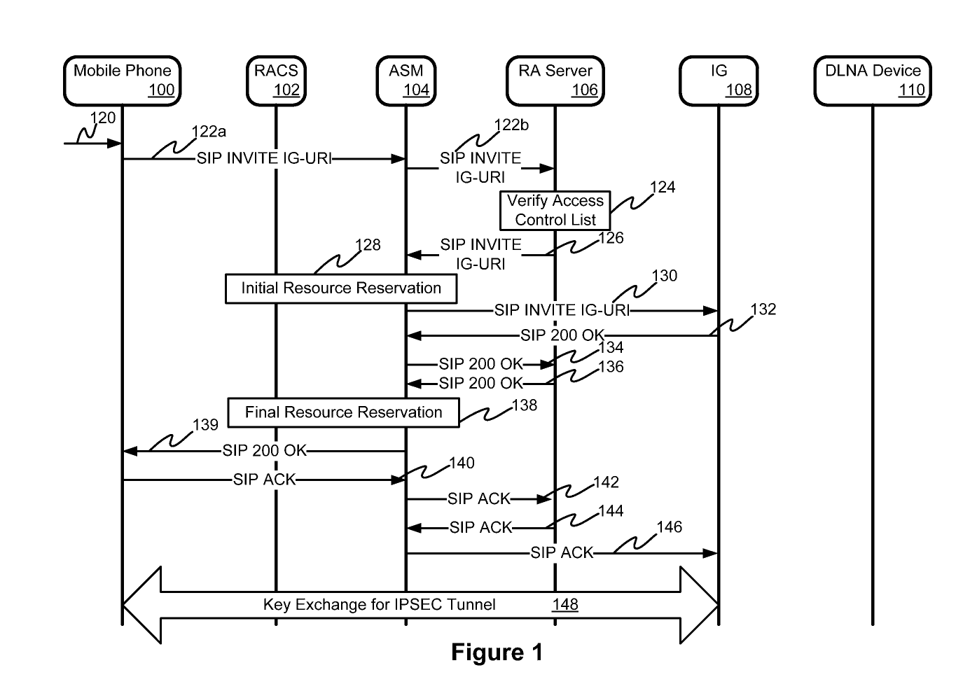

FIG. 1 illustrates an initial session setup that allows for the exchange of keys between the mobile platform (illustrated as a mobile phone, though one skilled in the art will appreciate that other mobile device could be substituted, as could any other device requesting transcoding services) and the IMS Gateway (IG) which is typically housed at the user premises. Mobile phone 100 receives instructions 120 from the user to request content from a DLNA Device 110 residing behind IG 108. Mobile Phone 100 issues a content request 122 (shown as 122a and 122b) to the IG 108. In one embodiment, the connection request is a SIP INVITE message that specifies the IG through the use of a universal resource indicator (URI) that can be resolved to an address associated with the IG 108 (e.g. IG-URI). The use of a URI allows the Mobile Phone 100 to specify IG 108 without knowing its current network address. One skilled in the art will appreciate that the SIP INVITE includes the appropriate IMS Communication Service Identifier (ICSI) as required by ETSI 185 010 standards to allow the ASM 104 to identify the incoming request as being a request related to remote access and route the request accordingly to the remote access server for further processing. This SIP INVITE message 122a is first relayed to Authentication and Session Management (ASM) node 104. ASM 104 forwards the received INVITE as 122b to the Remote Access (RA) Server 106. In process 124 RA Server 106 verifies the access rights of Mobile Phone 100 to content hosted behind IG 108 in a content store such as DLNA device 112. In the exemplary illustrated embodiment of FIG. 1, this process is performed by verifying that the requesting party is present on an Access Control List. Other methods of access right verification will be apparent to those skilled in the art and can be used without departing from the scope of the present invention. From this point forward, RA server 106 begins a process similar to the one specified in existing standards. In message 126, the RA server 106 issues an INVITE to ASM 104 which identifies IG 108. ASM 104 then begins a resource reservation process 128 with the Resource and Admission Control Subsystem (RACS) 102. ASM 104 then initiates a connection to IG 108 with SIP INVITE IG-URI 130 IG 108 replies, confirming the connection, with an acknowledgement such as SIP 200 OK message 132 which is sent to ASM 104. SIP 200 OK messages 134, 136 and 139 are then relayed back along the reverse path as messages 122a, 122b and 126. When ASM 104 receives SIP 200 OK 136 it can perform adjustments to the resource reservation made with RACS 102 in process 128.

At this point, Mobile Phone 100 can then send an acknowledgement (e.g. SIP ACK message 140) to the ASM 104, which in turn can send an acknowledgement to the RA server 106 in message 142. The RA Server 106 can then send an acknowledgement back to the ASM 104 in message 144. A final acknowledgement 146 is them sent from ASM 104 to IG 108. These acknowledgements mirror the paths of the INVITE described earlier. Upon completion of this process, the mobile phone 100 and IG 108 can begin a key exchange process to establish the desired IPSEC Tunnel in this exemplary embodiment. This allows the DLNA control traffic exchanged between the mobile device 100 and the residential home to be secured.

In the above described embodiment, the impact for implementing access control was placed upon the RA server 106, and as a result no interaction with an IPTV Control Server (IPTV CS) is required. Other embodiments may elect to make use the IPTV CS for these functions, in which case it would be a node on the above described message paths.

By moving transcoding functionality into the network, the end user can specify transcoding needs and an appropriate entity can be selected to perform the transcoding. The transcoding can be done using hardware specifically designed for the purpose, which removes the burden from home-based computers that are often poorly configured or designed for the task. A dedicated transcoding node can produce a content stream tailored to the needs of the specific mobile device. Encoding bit rates, resolution, codec selection and other encoding parameters can be selected for the particular mobile phone as opposed to selecting from a generic set of predefined options that may not be designed for any device in particular, or in a common scenario are designed for another device entirely.

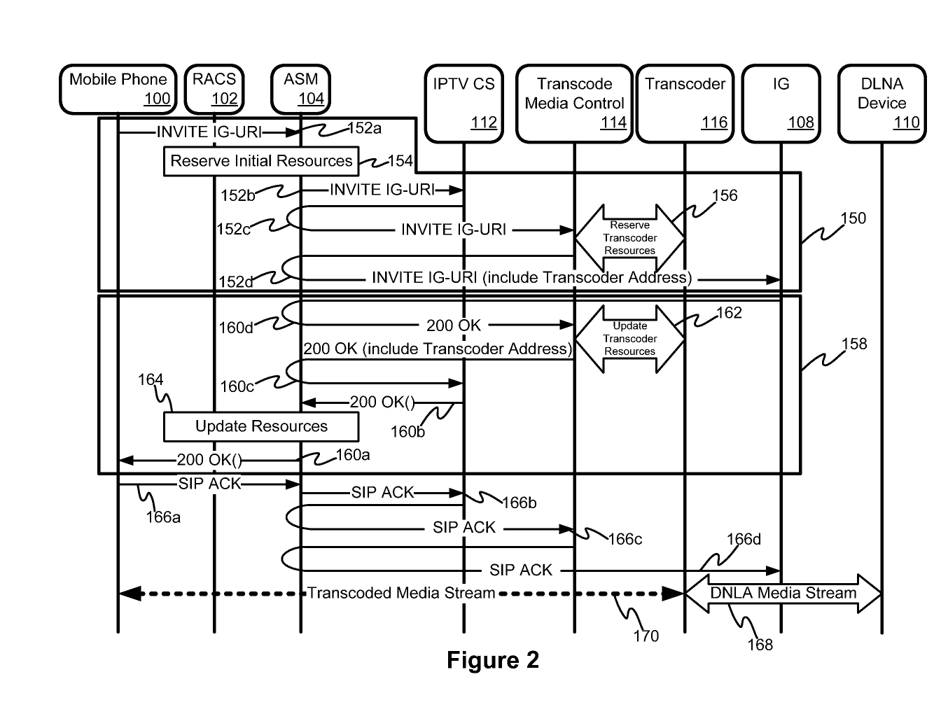

In FIG. 2, an exemplary embodiment of a method by which mobile device 100 requests transcoded content is shown in the form of a message passing diagram. One skilled in the art will appreciate that this is an exemplary embodiment and should not be considered to be limiting of the scope of the present invention. In this scenario, the mobile phone 100 must establish a separate channel from the DLNA control channel (whose setup was shown in FIG. 1) for streaming purposes. An IPTV Control Server (IPTV CS) is included to allow the insertion of a network based transcoding service, though one skilled in the art will appreciate that this functionality could be provided by another node without departing from the scope of the present invention. For the purposes of this example, it is assumed that the mobile device already has an established VPN with the IG for DLNA (access such as the VPN created by the call flow of FIG. 1). The call flow in FIG. 2 also assumes a proactive mode of transcoding where transcoders are engaged before the SIP INVITE is sent to the IG.

Mobile phone 100 issues a request 150 addressing IG 108, request 150 being used to request content from IG 108. Request 150 also includes an indication that transcoding is required. In one embodiment, request 150 addresses IG 108 through the use of a URI, and takes the form of a SIP INVITE message, such as message 152a which is first received by ASM 104. An SDP in the SIP INVITE message 152a specifies that transcoding is required and may optionally do so by including the source and target codec specifications in a form such as a=translation<Source, Target> where Source specifies the codec used to encode the content received by the transcoder, and Target specifies the codec used to encode the content that is output by the transcoder (to be transmitted to and rendered at the mobile station 100). The indication that transcoding is required is used by the IPTV CS 112 to determine that the INVITE message should be forwarded to a transcoding service. Upon receiving INVITE 152a, ASM 104 and RACS 102 undertake an initial resource reservation process 154. The details of the resource reservation process 154 are not germane to the present discussion and will be understood by those skilled in the art.

INVITE 152a is then relayed as message 152b to the IPTV CS 112, which upon recognizing that transcoding is required forwards it as 152c to the transcoding media controller (TCM) 114 through ASM 104. IPTV CS 112 can use the specified source and target codecs to select TCM 114 from a variety of other transcoding services. Upon receiving message 152c, TCM 114 reserves resources with transcoder 116 in process 156. TCM 114 then relays the INVITE to IG 108 as message 152d which includes the address of the transcoder 116 in the SDP (included in the SIP INVITE 152d) so that IG 108 can later send the content stream to the transcoder 116. As noted earlier, although there are particular advantages to having the IPTV CS 112 determine that the mobile device 100 is requesting transcoding, this functionality can be transferred to other nodes without departing from the scope of the present invention, and in some embodiments, the user equipment itself can specify the transcoding service to be used.

IG 108 can then begin the process of sending an acceptance of the request 150, as shown by acceptance 158. As shown in the illustrated exemplary embodiment of FIG. 2, a SIP 200 OK message can be sent along the reverse path of message 152a-d, with message 160d being sent from IG 108 to TCM 112 via ASM 104. TCM 114 can then update the transcoder resource reservation in step 162, and forward the 200 OK message to the IPTV CS 112 as message 160c. In this exemplary embodiment, message 160c includes the address of transcoder 116 and is routed through ASM 104. IPTV CS 112 then forwards the 200 OK message as 160b to ASM 104, which can then update the resource reservation with RACS 102 in process 164. ASM 104 can then forward the 200 OK message to mobile phone 100 as 160a.

Mobile phone 100 then sends an acknowledgement that the transmission should start as SIP ACK 166a-d following the same math as messages 152a-d respectively. The DLNA media stream can then be sent to transcoder 116 from DLNA device 110 in stream 168 where it is transcoded to the desired format and sent to mobile phone 100 in stream 170.

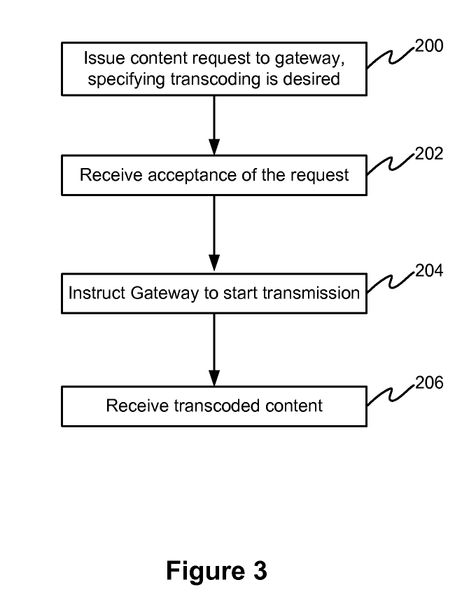

One skilled in the art will appreciate that the process of the present invention can be viewed as a method executed at one of a number of different nodes shown in FIGS. 1 and 2. At each node, the method can appear to be different, but when taken together, the above described process becomes clear. FIG. 3 is a flowchart illustrating a method of the present invention as seen from the perspective of the User Equipment, such as Mobile phone 100. In step 200, a content request is issued to the gateway. This content request preferably specifies that transcoding is required. In step 202, the user equipment receives an acceptance of the request, and responds by instructing the gateway to start transmission of the requested content in step 204. In step 206, the user equipment receives the transcoded copy of the requested content. As described above, the indication that transcoding is required can be provided in a number of different ways including: specifying a source and target codec to allow another node (e.g. IPTV CS) to select an appropriate transcoder; explicitly indicating a transcoding node; and other means including identifying to another node an identifier that is pre-associated with a standing request for transcoding services.

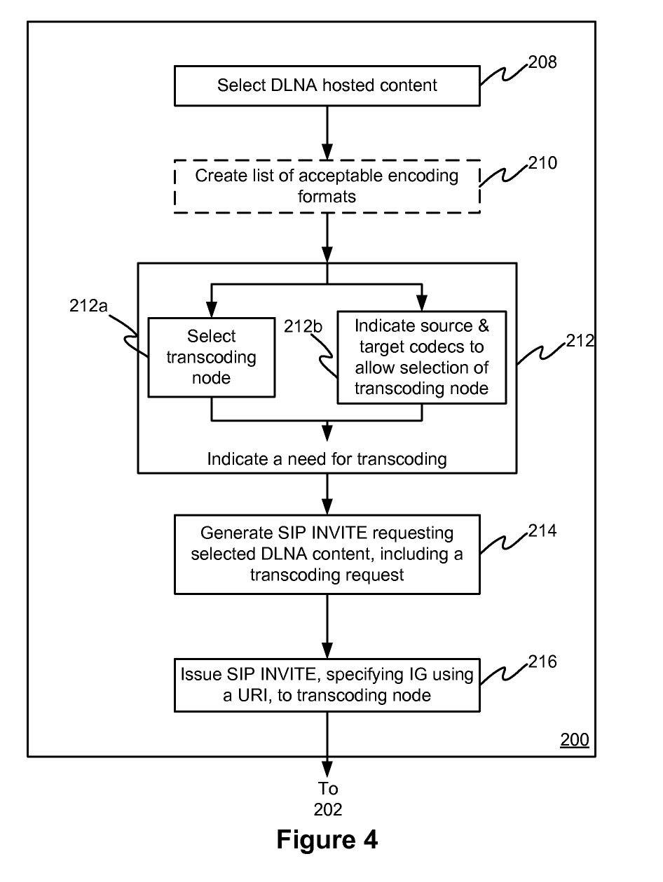

FIG. 4 illustrates an optional embodiment of the method illustrated in FIG. 3. Step 200 is shown having many sub-steps, none of which should be interpreted as being limiting of the scope of the present invention or as explicitly required, and some of which are not required in conjunction with the others. In step 208, the user, through the user equipment selects DLNA hosted content. In optional step 210 a list of acceptable encoding formats is created. The list created in step 210 can be used as an input factor into step 212, where a transcoding request is indicated by 212a in which a transcoding node is identified, or 212b where a source and target codec pair is specified, a transcoding node with the appropriate codec to fulfill the selections of step 210 is selected. In step 214, a SIP INVITE message is generated. This SIP INVITE message requests the selected DLNA content and specifies the transcoding instruction determined in step 212. In step 216, the generated SIP INVITE is issued, and is sent to the specified IG, behind which the DLNA content is hosted, through the use of a URI (IG URI).

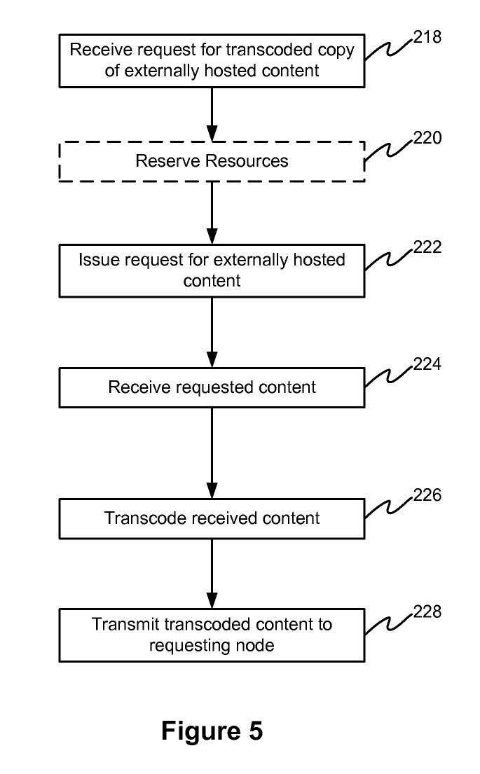

FIG. 5 illustrates a method of the present invention that can be carried out at a transcoding node of the present invention. In step 218, the transcoding node receives a request for a transcoded copy of externally hosted content. In this exemplary embodiment of step 220, the transcoding node reserve transcoding resources based on the transcoding specification included in the incoming request so that it is able to accommodate the request of step 218. In step 222, the transcoding node issues a request for externally hosted content. In step 224, the transcoding node receives the requested content, and begins transcoding it to a format preferably defined in the received request in step 226. In step 228, the transcoded content is transmitted to the requesting node.

One skilled in the art will appreciate that in some embodiments, the received request specifies both the source and target encoding formats to be used in the operation. Between issuing the request for externally hosted content in step 222, which includes specifying a content format in accordance with the information received in step 218, and receiving the requested content in step 224, the transcoding node may receive a confirmation that is then relayed to the requesting node. If such a confirmation is received, the method can also include the step of modifying the transcoding resource reservation made in step 220. In an alternate embodiment, user equipment can have a preselected target codec that is prearranged with the transcoding node. In such a case, the request received need not explicitly specify the target codec.

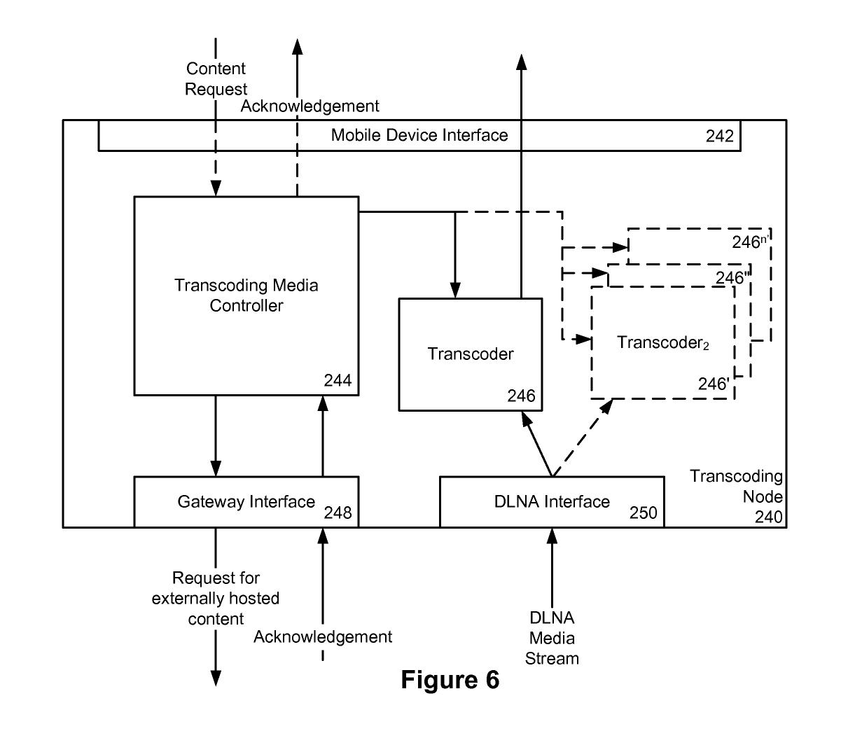

FIG. 6 illustrates a block diagram version of a transcoding node of the present invention. Transcoding node 240 has a mobile device interface 242 through which it communicates with mobile devices. Through mobile device interface 242, a transcoding media controller 244 receives a content request from an external mobile device. This content request, which typically is provided to the mobile device interface 242 by an intermediate node, preferably indicates an external source from which content is requested. The request can also indicate the encoding format of the requested content, and the encoding format to which the content should be transcoded. The transcoding media controller 244 makes use of a gateway interface 248 to issue a request for the content. The issued content request can specify that the content should be delivered to transcoder 246. The transcoding media controller 244 can, in accordance with the received content request, reserve resources with transcoder 246 to ensure that the transcoding process can be performed.

In response to issuing the request for externally hosted content, the transcoding node can receive, through the gateway interface 248, an acknowledgement and acceptance of the request. This acknowledgement can be used by the transcoding media controller 244 to update the resource reservation, and can be forwarded to the mobile device initiating the request through mobile device interface 242. In response to the acknowledgement, an instruction to commence streaming can be issued through the gateway interface 248.

When the requested content is received by the transcoding node 240 as a DLNA Media Stream, it is received through a DLNA interface 250, which can be incorporated within the gateway interface 248 in some embodiments. The content is preferably received as a DLNA media stream, and is provided to transcoder 246, where it is converted from the original format to a destination format indicated by the transcoding media controller 244. The destination format (also referred to as a target format) is determined in accordance with the received content request. The transcoded content is then forwarded to the requesting node through mobile device interface 242.

One skilled in the art will appreciate that a single transcoding media controller 244 can be provided access to a plurality of different transcoders, as illustrated by transcoder 246′, 246″ and 246^{n′}. Transcoders can be specific to certain sets of encoding formats, or can all be identical and capable of supporting conversion between the same sets of encoding formats. The transcoders can be selected by transcoding media controller 244 in accordance with the availability of resources (which can be determined during the above-described resource reservation), and the encoding formats required for the transcoding process.

One skilled in the art will appreciate that the transcoders need not be incorporated in the same physical system as the transcoding media controller, and instead can be external resources that are paired with the media controller. Such a setup allows for a transcoding media controller to be added to a network, and for the transcoding capabilities to be increased or decreased as needed. As more transcoders are introduced, the transcoding media controller can be configured to make use of them, without having to inform any other network nodes of their availability. Where transcoders 246, 246′ . . . 246^{n′} are provided as physically separate network elements, they will typically have their own mobile device interface. Where a single system houses multiple logical elements, the interfaces to mobile devices, the gateway and the DLNA content can be integrated with each other, and provided by the same network interface.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of requesting content from a content source behind a gateway, the method comprising:
issuing, over a network interface, a request addressed to the gateway for content from the content source, the request specifying that transcoding of the requested content is desired;
receiving, from the gateway, an indication of acceptance of the request;
instructing the gateway to begin transmission of the requested content; and
receiving, from the transcoding node, a transcoded version of the requested content.

2. The method of claim 1 wherein the content source stores digital media content in accordance with standards established by the Digital Living Network Alliance.

3. The method of claim 1 wherein the gateway is an Internet Multimedia Subsystem (IMS) gateway.

4. The method of claim 1 wherein specifying that transcoding is desired includes including an indication for another node to transmit the request to a transcoding node.

5. The method of claim 4 wherein the indication for another node is a tag specifying at least one of a source and target codec.

6. The method of claim 1 wherein the step of issuing a request includes generating a Session Initiation Protocol (SIP) INVITE message.

7. The method of claim 6 wherein the SIP INVITE message is addressed to the gateway, and transmitted through a transcoding node selected in accordance with the specified desire for transcoding.

8. The method of claim 7 wherein the SIP INVITE message is addressed to the gateway through the use of a Universal Resource Indicator associated with the gateway.

9. The method of claim 7 wherein the SIP INVITE message includes a Session Description Protocol compliant instruction specifying a preferred format to transcode requested content to.

10. The method of claim 7 wherein the step of receiving the indication of acceptance includes receiving a SIP 200 OK message from the transcoding node.

11. The method of claim 1 wherein the step of instructing includes transmitting a SIP ACK message to the gateway.

12. A method of transcoding content on demand, the method comprising:
receiving, at a transcoding node, from a requesting node, a request for a transcoded copy of content from a content source;
forwarding, to the content source a request for the content;
receiving the requested content from the content source in a first encoding format;
creating a transcoded copy of the received content by translating the received content from the first encoding format to a second encoding format; and
forwarding the transcoded copy of the content to a node determined in accordance with the received request.

13. The method of claim 12 wherein the step of receiving the request includes receiving the request from an Internet Protocol Television Control Server on behalf of the requesting node.

14. The method of claim 12 wherein the request for transcoded content includes a session description protocol compliant specification of at least one of the first and second encoding formats.

15. The method of claim 12 wherein the received request includes the address to which the request for content should be forwarded.

16. The method of claim 15 wherein the address is provided as a universal resource indicator that can be resolved to the address of a gateway through which the content source is accessible.

17. The method of claim 12 wherein the step of receiving the request includes receiving the request from a mobile device.

18. The method of claim 12 wherein the request includes a request for content compliant with Digital Living Network Alliance standards.

19. The method of claim 12, wherein the step of forwarding the transcoded content includes forwarding the transcoded content to the requesting node.

20. The method of claim 12, wherein the step of forwarding the transcoded content includes forwarding the transcoded content to a node specified by the requesting node.

21. A transcoding node for receiving requests for transcoded copies of externally hosted content, the transcoding node comprising:
a transcoder for receiving externally hosted content in a first encoding format, for converting the externally hosted content from the first encoding format to a second encoding format, and for transmitting the converted content; and
a transcoding media controller for receiving the request, for generating and transmitting a request for the externally hosted content in accordance with the received request, for instructing the transcoder to convert content received in response to the transmitted request to a format selected in accordance with the received request, and for instructing the transcoder to transmit the converted content to an end user node.

22. The transcoding node of claim 21 further including a mobile device interface for receiving the requests for transcoded copies from a mobile device, for forwarding the received requests to the transcoding media controller, and for receiving the converted content from the transcoder and transmitting the converted content on behalf of the transcoder.

23. The transcoding node of claim 21 further including a gateway interface for receiving the request for externally hosted content from the transcoding media controller and for transmitting the request on behalf of the transcoding media controller, for receiving from an external node the requested content and for relaying the received requested content to the transcoder.

24. The transcoding node of claim 23 further including a plurality of transcoders selectable by the transcoding media controller, each of the plurality of transcoders operably connected to the gateway interface for receiving from the interface the received requested content.
